(19) United States
(12) Patent Application Publication
(10) Pub. No.: US 2025/0388808 A1
(43) Pub. Date: Dec. 25, 2025

(54) MODIFIED QUANTUM DOT, QUANTUM DOT COMPOSITION, AND FILM

(71) Applicant: INDUSTRIAL TECHNOLOGY RESEARCH INSTITUTE, Hsinchu (TW)

(72) Inventors: Yi-Hsiu PAN, Zhudong Township (TW); Hsiang-Jui CHEN, Hsinchu City (TW); Jheng-Ying LI, Taoyuan City (TW)

(73) Assignee: INDUSTRIAL TECHNOLOGY RESEARCH INSTITUTE, Hsinchu (TW)

(21) Appl. No.: 19/020,465

(22) Filed: Jan. 14, 2025

(30) Foreign Application Priority Data
Jun. 21, 2024 (TW) 113123078

(51) Int. Cl. C09K 11/02

(52) U.S. Cl. CPC C09K 11/025

(57) ABSTRACT

A modified quantum dot includes a quantum dot, polyhedral oligomeric silsesquioxane (POSS) grafted onto the surface of the quantum dot, and acrylate-containing siloxane oligomer grafted onto the surface of the quantum dot. The quantum dot composition includes the modified quantum dot, a modified high refractive particle, a scattering particle, an initiator, and an acrylate monomer. The modified high refractive particle includes a high refractive particle and a silane coupling agent having a double-bond grafted onto the surface of the high refractive particle. The high refractive particle includes (1) an oxide of zinc and titanium, and zinc and titanium have a weight ratio of 1:0.4 to 1:0.9, (2) an oxide of zirconium and titanium, and zirconium and titanium have a weight ratio of 1:0.1 to 1:2, or (3) an oxide of zinc and zirconium, and zinc and zirconium have a weight ratio of 1:0.8 to 1:2.

### CROSS REFERENCE TO RELATED APPLICATIONS

The present application is based on, and claims priority from, Taiwan Application Serial Number 113123078, filed on Jun. 21, 2024, the disclosure of which is hereby incorporated by reference herein in its entirety.

### TECHNICAL FIELD

The technical field relates to a modified quantum dot, a quantum dot composition, and a film.

### BACKGROUND

Mini/micro-LED flexible panels will become mainstream panels in the future due to the demand for smart display applications and automotive panels. Since quantum dot (QD) has a narrow half-wave width, it can be used as a color conversion layer of mini/micro-LED and combined with blue LED to achieve high color saturation of the three colors of RGB. QD has a high photoluminescence quantum yield, a small diameter, and good solution-processing properties, thereby having the potential to be used as a color conversion material in mini/micro-LEDs. However, in terms of material, the color conversion efficiency of QD still needs to be improved.

### SUMMARY

One embodiment of the disclosure provides a modified quantum dot, including a quantum dot; polyhedral oligomeric silsesquioxane (POSS) grafted onto the surface of the quantum dot; and acrylate-containing siloxane oligomer grafted onto the surface of the quantum dot.

One embodiment of the disclosure provides a quantum dot composition, including: the described modified quantum dot; a modified high refractive particle; a scattering particle; an initiator; and an acrylate monomer. The modified high refractive particle includes a high refractive particle; and a silane coupling agent having a double-bond grafted onto the surface of the high refractive particle. The high refractive particle includes (1) an oxide of zinc and titanium, and zinc and titanium have a weight ratio of 1:0.4 to 1:0.9, (2) an oxide of zirconium and titanium, and zirconium and titanium have a weight ratio of 1:0.1 to 1:2, or (3) an oxide of zinc and zirconium, and zinc and zirconium have a weight ratio of 1:0.8 to 1:2.

One embodiment of the disclosure provides a film formed by reacting the described quantum dot composition through light irradiation or heating.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a modified quantum dot, including: a quantum dot, polyhedral oligomeric silsesquioxane (POSS) grafted onto the surface of the quantum dot, and acrylate-containing siloxane oligomer grafted onto the surface of the quantum dot. For example, the quantum dot, polyhedral oligomeric silsesquioxane having a thiol group (POSS-SH), and acrylate-containing siloxane oligomer having a thiol group (acrylate-containing siloxane oligomer-SH) can be reacted to graft POSS and the acrylate-containing siloxane oligomer onto the surface of the quantum dot. In some embodiments, POSS-SH has a chemical structure as

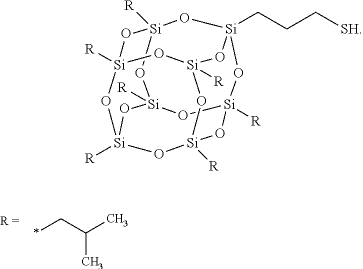

In the above chemical structure, the alkylene group between POSS and the thiol group can be C₂₋₁₀ alkylene group, and not be limited to the propylene group. In addition, R can be a C₃₋₁₀ linear alkyl group or a C₃₋₁₀ branch alkyl group, and not be limited to the isobutyl group. The framework of POSS can be hexahedral oligosesquioxane, octahedral oligosesquioxane, decahedral oligosesquioxane, or dodecahedral oligosesquioxane. In some embodiments, the acrylate-containing siloxane oligomer having a thiol group has a chemical structure of

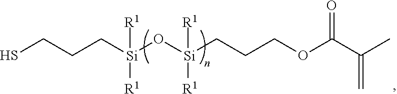

wherein R¹ is OCH₃, and n is an integer of 1 to 6.

Although POSS and the acrylate-containing siloxane oligomer are grafted onto the surface of the quantum dot through the thiol group in the above description, it should be understood that the thiol group can be replaced with carboxylic acid group, amine group, hydroxy group, or another suitable functional group, as long as it can be grafted onto the surface of the quantum dot.

In some embodiments, the quantum dot includes cadmium selenide (CdSe), cadmium sulfide (CdS), indium arsenide (InAs), indium phosphide (InP), or a combination thereof. In some embodiments, the quantum dot can be a core-shell structure, such as a CdSe/ZnSe core-shell structure or a CdS/ZnS core-shell structure. In some embodiments, the quantum dot has a diameter of 1 nm to 20 nm. In some embodiments, the quantum dot with a core-shell structure has a diameter of 4 nm to 20 nm or 5 nm to 20 nm. In some embodiments, the quantum dot without a core-shell structure has a diameter of 1 nm to 4 nm. The shell may further enhance the photoluminescence efficiency. The larger diameter of the quantum dot means a greater number of shells, i.e. a higher luminous efficiency.

In some embodiments, the quantum dot and the polyhedral oligomeric silsesquioxane (POSS) have a weight ratio of 1:0.5 to 1:5. If the amount of POSS is not enough, the quantum yield of the modified quantum dot will decay excessively at high temperatures. If the amount of POSS is too high, it will be difficult to disperse the modified quantum dot in a quantum dot composition.

In some embodiments, the quantum dot and the acrylate-containing siloxane oligomer have a weight ratio of 1:0.5 to 1:1.5. If the amount of the acrylate-containing siloxane oligomer is too low, it will be difficult to disperse the modified quantum dot in a quantum dot composition. If the amount of the acrylate-containing siloxane oligomer is too large, the quantum yield of the modified quantum dot will decay excessively at high temperatures.

One embodiment of the disclosure provides a quantum dot composition, including: the described modified quantum dot, a modified high refractive particle, a scattering particle, an initiator; and an acrylate monomer. The modified high refractive particle includes a high refractive particle and a silane coupling agent, having a double-bond, grafted onto the surface of the high refractive particle. When the high refractive particle includes (1) an oxide of zinc and titanium, zinc and titanium have a weight ratio of 1:0.4 to 1:0.9. If the zinc amount is too much, the particle will tend to precipitate, and a stable crystal state of the high refractive particle will prone to be deteriorated. If the titanium amount is too much, the high refractive particle will quickly gel during the reaction and cannot be used. When the high refractive particle includes (2) an oxide of zirconium and titanium, zirconium and titanium have a weight ratio of 1:0.1 to 1:2. If the titanium amount is too much, the color will be deep yellow and cannot keep a high light-transmittance and a low b* value at visible light band. When the high refractive particle includes (3) an oxide of zinc and zirconium, zinc and zirconium have a weight ratio of 1:0.8 to 1:2. In some embodiments, zine and zirconium have a weight ratio of 1:0.8 to 1:1.8. If the zinc amount is too much, the particle will tend to precipitate during the reaction. If the zirconium amount is too much, the reaction will be gelled by overly bonding.

In one embodiment, the high refractive particle is formed by hydrolyzing a zinc source to form zinc oxide, and then condensing it with a titanium source. The high refractive particle mainly includes zinc, titanium, and oxygen (e.g. an oxide of zinc and titanium). The surface of the high refractive particle includes a plurality of hydroxy groups and alkoxy groups. In one embodiment, the high refractive particle is the oxide of zinc and titanium, other than a mixture of zinc oxide and titanium oxide (e.g. the titanium of the titanium oxide and the oxygen of the zinc oxide have no bonding therebetween, and the oxygen of the titanium oxide and the zinc of the zinc oxide have no bonding therebetween). Compared to the high refractive particle of the oxide of zinc and titanium, the mixture of the zinc oxide and the titanium oxide will precipitate as a solid. Subsequently, a silane coupling agent having the double-bond is reacted with the high refractive particle, such that the Si—O-alkyl group of the silane is reacted with —OR group (R═H or alkyl) on the surface of the high refractive particle to form Zn/Ti—O—Si bonding, in which the silane coupling agent is grafted onto the surface of the high refractive particle. In some embodiments, the modified high refractive particle can be produced by other methods. One skilled in the art may adopt suitable reactants to form the described modified high refractive particle.

In one embodiment, the high refractive particle is formed by condensing a zirconium source and a titanium source. The high refractive particle mainly includes zirconium, titanium, and oxygen (e.g. an oxide of zirconium and titanium). The surface of the high refractive particle includes a plurality of hydroxy groups and alkoxy groups. In one embodiment, the high refractive particle is the oxide of zirconium and titanium, other than a mixture of zirconium oxide and titanium oxide (e.g. the titanium of the titanium oxide and the oxygen of the zirconium oxide have no bonding therebetween, and the oxygen of the titanium oxide and the zirconium of the zirconium oxide have no bonding therebetween). Compared to the high refractive particle of the oxide of zirconium and titanium, the high refractive particle of the mixture of the zirconium oxide and the titanium oxide will precipitate as a solid. Subsequently, a silane coupling agent having the double-bond is reacted with the high refractive particle, such that the Si—O-alkyl group of the silane is reacted with —OR group (R═H or alkyl) on the surface of the high refractive particle to form Zr/Ti—O—Si bonding, in which the silane coupling agent is grafted onto the surface of the high refractive particle. In some embodiments, the modified high refractive particle can be produced by other methods. One skilled in the art may adopt suitable reactants to form the described modified high refractive particle.

In one embodiment, the high refractive particle is formed by hydrolyzing a zinc source to form zinc oxide, and then condensing it with a zirconium source. The high refractive particle mainly includes zinc, zirconium, and oxygen (e.g. an oxide of zinc and zirconium). The surface of the high refractive particle includes a plurality of hydroxy groups and alkoxy groups. In one embodiment, the high refractive particle is the oxide of zinc and zirconium, other than a mixture of zinc oxide and zirconium oxide (e.g. the zinc of the zinc oxide and the oxygen of the zirconium oxide have no bonding therebetween, and the oxygen of the zinc oxide and the zirconium of the zirconium oxide have no bonding therebetween). Compared to the high refractive particle of the oxide of zinc and zirconium, the high refractive particle of the mixture of the zinc oxide and the zirconium oxide will precipitate as a solid. Subsequently, a silane coupling agent having the double-bond is reacted with the high refractive particle, such that the Si—O-alkyl group of the silane is reacted with —OR group (R═H or alkyl) on the surface of the high refractive particle to form Zn/Zr—O—Si bonding, in which the silane coupling agent is grafted onto the surface of the high refractive particle. In some embodiments, the modified high refractive particle can be produced by other methods. One skilled in the art may adopt suitable reactants to form the described modified high refractive particle.

In some embodiments, the zinc source can be zinc acetate, zinc perchlorate, or zinc bromide. In some embodiments, the titanium source can be titanium isopropoxide, titanium tetrachloride, or titanium butoxide. In some embodiments, the zirconium source can be zirconium n-propoxide, zirconium isopropoxide, or zirconium tetrachloride.

In some embodiments, the total weight of zinc and titanium (or the total weight of zirconium and titanium or the total weight of zinc and zirconium) and the weight of the silane coupling agent having the double-bond have a ratio of 1:0.1 to 1:3, or 1:0.1 to 1:1.5. If the amount of silane coupling agent having the double-bond is too low, the modified high refractive particle has poor compatibility with other components of the quantum dot composition. If the amount of silane coupling agent having the double-bond is too high, the quantum dot composition will tend to be gelled.

In some embodiments, the high refractive particle has an average diameter of 10 nm to 120 nm, such as 15 nm to 55 nm. If the average diameter of the high refractive particle is too small, the refractive effect of a film made of the disclosed quantum dot composition will be unsatisfactory. If the average diameter of the high refractive particle is too large, the optical properties of the film will be decreased.

In some embodiments, the silane coupling agent having the double-bond comprises 3-(trimethoxysilyl) propyl acrylate, 3-(triethoxysilyl) propyl acrylate, 3-(triethoxysilyl) propyl isocyanate, or

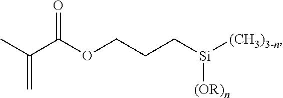

wherein R is methyl or ethyl, and n is an integer of 1-3.

In some embodiments, the modified quantum dot and the modified high refractive particle have a weight ratio of 1:0.1 to 1:1. If the amount of modified high refractive particle is too low, the optical properties of the film will be negatively influenced. If the amount of modified high refractive particle is too high, the modified high refractive particle will tend to precipitate.

In some embodiments, the scattering particle is titanium dioxide, silicon oxide, or a combination thereof, and the scattering particle has an average diameter of 100 nm to 1000 nm. If the average diameter of the scattering particle is too small, the scattering particle will tend to aggregate and be unstable. If the average diameter of the scattering particle is too large, the scattering particle will tend to precipitate and the external quantum efficiency (EQE) and optical density (OD) of the film will be too low.

In some embodiments, the modified quantum dot and the scattering particle have a weight ratio of 1:0.5 to 1:1.5. If the amount of the scattering particle is too low, the scattering particle will not provide an efficient scattering effect, thereby resulting an overly low EQE and OD of the film. If the amount of the scattering particle is too large, the scattering particle will tend to precipitate to cause an overly low EQE and OD of the film.

In some embodiments, the initiator includes photo initiator, thermal initiator, or a combination thereof. The photo initiator can be 2,4,6-trimethylbenzoyldiphenylphosphine oxide (TPO), diethoxyacetophenone, benzoin methyl ether, benzophenone, isopropyl thioxanthone, or another suitable photo initiator. The thermal initiator can be azobisisobutyronitrile (AIBN), tert-butyl peroxybenzoate, lauroyl peroxide, or another suitable thermal initiator.

In some embodiments, the modified quantum dot and the initiator have a weight ratio of 1:0.1 to 1:1. If the amount of the initiator is too low, the reaction will be incomplete and the film cannot be cured. If the amount of the initiator is too much, the reaction will be too fast and the film will tend to crack.

In some embodiments, the acrylate monomer includes hydroxyethyl methacrylate, 2-phenoxyethyl acrylate, β-carboxyethyl acrylate, isobornyl acrylate, hexamethylene diacrylate, isodecyl acrylate, trimethylolpropane trimethacrylate, or a combination thereof.

In some embodiments, the modified quantum dot and the acrylate monomer have a weight ratio of 1:3 to 1:5. If the amount of the acrylate monomer is too low, the composition (ink) will be too viscous to be coated as a film. If the amount of the acrylate monomer is too much, the optical properties of the film will be poor.

One embodiment of the disclosure provides a film being formed by reacting the described quantum dot composition through light irradiation or heating. In the modified quantum dot of the quantum dot composition, POSS grafted onto the surface of the quantum dot is beneficial to reduce the quantum yield decay degree of the film at high temperatures. The acrylate-containing siloxane oligomer grated to the surface of the quantum dot is beneficial to increase the compatibility between the modified quantum dot, the modified high refractive particle, and the acrylate monomer. As such, the stability of the quantum dot composition can be increased (e.g. lowering the turbiscan stability index (TSI) of the quantum dot composition). The modified quantum dot can be collocated with the modified high refractive particle to further improve the stability of the quantum dot composition (e.g. decreasing the sedimentation coefficient of the quantum dot composition), external quantum efficiency of the film, and the optical density of the film. The scattering particle in the quantum dot composition may increase the refractive index of the film. The modified quantum dot, the modified high refractive particle, and the scattering particle can be uniformly dispersed in the acrylate monomer. The film can be formed on a blue LED to convert a blue light to a red light or a green light. In other words, the quantum dot composition of the disclosure can be used to form a light-emitting device.

Below, exemplary embodiments will be described in detail so as to be easily realized by a person having ordinary knowledge in the art. The inventive concept may be embodied in various forms without being limited to the exemplary embodiments set forth herein.

### EXAMPLES

### Comparative Example 1

0.1 mg of non-modified quantum dots C527 (CdSe/ZnS core-shell structure, commercially available from Taiwan Nanocrystal Inc., quantum yield=95%, and full width at half maximum <25 nm) was analyzed by a quantum efficiency measurement system QE-2000 (commercially available from Otsuka Tech Electronics Co., Ltd.) to measure its quantum yield (94.94%) and full width at half maximum (20 nm). The non-modified quantum dots were placed in an oven at 180° C. for 2 hours, and then analyzed by the quantum efficiency measurement system QE-2000 to measure its quantum yield (84.16%). Accordingly, the non-modified quantum dots had a quantum yield decay of about 11% at high temperatures.

### Example 1

1 part by weight of the non-modified quantum dots C527, 1 part by weight of polyhedral oligomeric silsesquioxane having a thiol group (POSS-SH), 1 part by weight of acrylate-containing siloxane oligomer having a thiol group (acrylate-containing siloxane oligomer-SH), 0.06 parts by weight of D-cysteine, and 0.78 parts by weight of mercaptosuccinic acid were added into 4.6 parts by weight of tetrahydrofuran (THF). The mixture was heated to 100° C. to reflux and react for 6 hours, such that POSS and the acrylate-containing siloxane oligomer were grafted onto the surface of the quantum dots C527. The reaction result was cooled to room temperature and then filtered to obtain modified quantum dots. Energy-dispersive X-ray spectroscopy (EDX) analysis revealed the presence of a silicon signal on the modified quantum dots, indicating that POSS and the acrylate-containing siloxane oligomer were grafted onto the quantum dots C527. The POSS-SH, commercially available from SIGMA-ALDRICH, had a chemical structure of

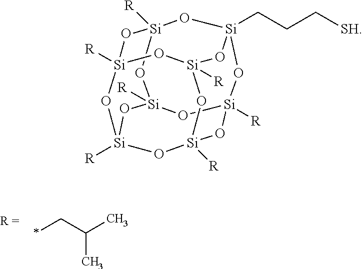

The acrylate-containing siloxane oligomer having a thiol group had a chemical structure of

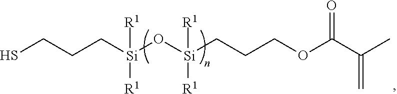

in which R¹ is OCH₃, n is an integer of 1 to 6, and was synthesized by a method referring to Wood Science and Technology, Vol. 55, pages 887-918, (2021).

0.01 mg of modified quantum dots was analyzed by the quantum efficiency measurement system QE-2000 to measure its quantum yield (91.53%) and full width at half maximum (20 nm). The modified quantum dots were placed in an oven at 180° C. for 2 hours, and then analyzed by the quantum efficiency measurement system QE-2000 to measure its quantum yield (84.48%). Accordingly, the modified quantum dots had a quantum yield decay of about 7% at high temperatures.

### Example 2

1 part by weight of the non-modified quantum dots C527, 2 parts by weight of POSS-SH, 1 part by weight of the acrylate-containing siloxane oligomer having a thiol group, 0.06 parts by weight of D-cysteine, and 0.78 parts by weight of mercaptosuccinic acid were added into 4.6 parts by weight of THF. The mixture was heated to 100° C. to reflux and react for 6 hours, such that POSS and the acrylate-containing siloxane oligomer were grafted onto the surface of the quantum dots C527. The reaction result was cooled to room temperature and then filtered to obtain modified quantum dots. Energy-dispersive X-ray spectroscopy (EDX) analysis revealed the presence of a silicon signal on the modified quantum dots, indicating that POSS and the acrylate-containing siloxane oligomer were grafted onto the quantum dots C527.

0.01 mg of the modified quantum dots was analyzed by the quantum efficiency measurement system QE-2000 to measure its quantum yield (90.64%) and full width at half maximum (20 nm). The modified quantum dots were placed in an oven at 180° C. for 2 hours, and then analyzed by the quantum efficiency measurement system QE-2000 to measure its quantum yield (89.63%). Accordingly, the modified quantum dots had a quantum yield decay of about 1% at high temperatures.

### Example 3

1 part by weight of the non-modified quantum dots C527, 3 parts by weight of POSS-SH, 1 part by weight of the acrylate-containing siloxane oligomer having a thiol group, 0.06 parts by weight of D-cysteine, and 0.78 parts by weight of mercaptosuccinic acid were added into 4.6 parts by weight of THF. The mixture was heated to 100° C. to reflux and react for 6 hours, such that POSS and the acrylate-containing siloxane oligomer were grafted onto the surface of the quantum dots C527. The reaction result was cooled to room temperature and then filtered to obtain modified quantum dots. Energy-dispersive X-ray spectroscopy (EDX) analysis revealed the presence of a silicon signal on the modified quantum dots, indicating that POSS and the acrylate-containing siloxane oligomer were grafted onto the quantum dots C527.

0.01 mg of the modified quantum dots was analyzed by the quantum efficiency measurement system QE-2000 to measure its quantum yield (89.33%) and full width at half maximum (20 nm). The modified quantum dots were placed in an oven at 180° C. for 2 hours, and then analyzed by the quantum efficiency measurement system QE-2000 to measure its quantum yield (84.84%). Accordingly, the modified quantum dots had a quantum yield decay of about 5% at high temperatures.

As shown in the comparison between Comparative Example 1 and Examples 1 to 3, the modified quantum dots had a lower quantum yield decay at high temperatures. POSS might efficiently improve the thermal stability of the quantum dots.

### Example 4

5 g of zinc acetate, 20 g of isopropanol, and 1.9 g of ethanolamine were heated to 80° C. to be dissolved and reacted for 5 minutes. Subsequently, 10 g of titanium isopropoxide and 0.25 g of isopentanedione were added to the reaction mixture, and further reacted at 80° C. for 4 hours to form high refractive particles. The high refractive particles included an oxide of zinc and titanium, and zinc and titanium had a weight ratio of 1:0.6. 2.2 g of (3-glycidyloxypropyl) trimethoxysilane was then added to perform a surface modification. The total weight of zinc and titanium in the high refractive particles and the weight of (3-glycidyloxypropyl) trimethoxysilane had a ratio of 1:0.15. The Si—O—CH₃ of the silane and the —OR (R═H or CH (CH₃)₂) on the surface of the high refractive particles could react to form Zn/Ti—O—Si bonding, such that the silane being grafted onto the surface of the high refractive particles to form modified high refractive particles, and the high refractive particles had an average diameter of 40 nm.

### Example 5

5 g of zinc acetate, 20 g of isopropanol, and 1.9 g of ethanolamine were heated to 80° C. to be dissolved and reacted for 5 minutes. Subsequently, 10 g of titanium isopropoxide and 0.25 g of isopentanedione were added to the reaction mixture, and further reacted at 80° C. for 8 hours to form high refractive particles. The high refractive particles included an oxide of zinc and titanium, and zinc and titanium had a weight ratio of 1:0.6. 2.2 g of (3-glycidyloxypropyl) trimethoxysilane was then added to perform a surface modification. The total weight of zinc and titanium in the high refractive particles and the weight of (3-glycidyloxypropyl) trimethoxysilane had a ratio of 1:0.15. The Si—O—CH₃ of the silane and the —OR (R═H or CH (CH₃)₂) on the surface of the high refractive particles could react to form Zn/Ti—O—Si bonding, such that the silane being grafted onto the surface of the high refractive particles to form modified high refractive particles, and the high refractive particles had an average diameter of 80 nm.

### Example 6

15 g of zirconium n-propoxide, 15 g of titanium isopropoxide, 20 g of isopropanol, and 0.25 g of isopentanedione were reacted at 80° C. for 8 hours to form high refractive particles. The high refractive particles included an oxide of zirconium and titanium, and zirconium and titanium had a weight ratio of 1:0.9. 3 g of (3-glycidyloxypropyl) trimethoxysilane was then added to perform a surface modification. The total weight of zirconium and the titanium in the high refractive particles and the weight of (3-glycidyloxypropyl) trimethoxysilane had a ratio of 1:0.1. The Si—O—CH₃ of the silane and the —OR (R═H or CH (CH₃)₂) on the surface of the high refractive particles could react to form Zr/Ti—O—Si bonding, such that the silane being grafted onto the surface of the high refractive particles to form modified high refractive particles, and the high refractive particles had an average diameter of 40 nm.

### Example 7

5 g of zinc acetate, 20 g of isopropanol, and 1.9 g of ethanolamine were heated to 80° C. to be dissolved and reacted for 5 minutes. Subsequently, 10 g of titanium isopropoxide and 0.25 g of isopentanedione were added to the reaction mixture, and further reacted at 80° C. for 8 hours to form high refractive particles. The high refractive particles included an oxide of zinc and titanium, and zinc and titanium had a weight ratio of 1:0.6. 2.2 g of 3-(trimethoxysilyl) propyl acrylate was then added to perform a surface modification. The total weight of zinc and titanium in the high refractive particles and the weight of 3-(trimethoxysilyl) propyl acrylate had a ratio of 1:0.15. The Si—O—CH₃ of the silane and the —OR (R═H or CH (CH₃)₂) on the surface of the high refractive particles could react to form Zn/Ti—O—Si bonding, such that the silane being grafted onto the surface of the high refractive particles to form modified high refractive particles, and the high refractive particles had an average diameter of 75 nm.

### Example 8

5 g of zinc acetate, 20 g of isopropanol, and 0.48 M of KOH (3 mL) were heated to 80° C. to be dissolved and reacted for 5 minutes. Subsequently, 10 g of zirconium n-propoxide was added to the reaction mixture, and further reacted at 80° C. for 8 hours to form high refractive particles. The high refractive particles included an oxide of zinc and zirconium, and zinc and zirconium had a weight ratio of 1:1.8. 2.2 g of (3-glycidyloxypropyl) trimethoxysilane was then added to perform a surface modification. The total weight of zinc and zirconium in the high refractive particles and the weight of (3-glycidyloxypropyl) trimethoxysilane had a ratio of 1:0.15. The Si—O—CH₃ of the silane and the —OR (R═H or CH (CH₃)₂) on the surface of the high refractive particles could react to form Zn/Zr—O—Si bonding, such that the silane being grafted onto the surface of the high refractive particles to form modified high refractive particles, and the high refractive particles had an average diameter of 40 nm.

### Example 9

15 parts by weight of the modified quantum dots in Example 2, 3 parts by weight of the modified high refractive particles in Example 8, 10 parts by weight of titanium dioxide serving as scattering particles, 3 parts by weight of photo initiator TPO, 34.5 parts by weight of hexamethylene diacrylate, and 34.5 parts by weight of isodecyl acrylate were mixed to form an ink (a quantum dot composition). The ink was analyzed by a colloidal stability analyzer (Turbiscan Tower, commercially available from Formulaction) to measure its turbiscan stability index (TSI). In general, an ink having a TSI of >5 means that the ink has poor stability. An ink having a TSI of 3 to 5 means that the ink has ordinary stability. An ink having a TSI of <3 means that the ink has excellent stability. The ink in Example 9 had a TSI of 2.7. The ink was spun-coated on glass to form a film having a thickness of about 10 micrometers, and then cured by UV irradiation. The cured film was analyzed by OLED integrating sphere measurement system (SLM-12C, commercially available from ISUZU OPTICS CORP) to measure its external quantum efficiency (EQE, 42.15%) and optical density (OD, 1.71). Higher EQE means better light efficiency. Higher OD means higher conversion efficiency of blue light into green light (or red light).

### Example 10

15 parts by weight of the modified quantum dots in Example 2, 5 parts by weight of the modified high refractive particles in Example 8, 10 parts by weight of titanium dioxide serving as scattering particles, 3 parts by weight of photo initiator TPO, 33.5 parts by weight of hexamethylene diacrylate, and 33.5 parts by weight of isodecyl acrylate were mixed to form an ink. The ink was analyzed by Turbiscan Tower to measure its TSI. The ink had a TSI of 2.5. The ink was spun-coated on glass to form a film having a thickness of about 10 micrometers, and then cured by UV irradiation. The cured film was analyzed by SLM-12C to measure its EQE (44.95%) and OD (1.86).

### Example 11

15 parts by weight of the modified quantum dots in Example 2, 10 parts by weight of the modified high refractive particles in Example 8, 10 parts by weight of titanium dioxide serving as scattering particles, 3 parts by weight of photo initiator TPO, 31 parts by weight of hexamethylene diacrylate, and 31 parts by weight of isodecyl acrylate were mixed to form an ink. The ink was analyzed by Turbiscan Tower to measure its TSI. The ink had a TSI of 3.6. The ink was spun-coated on glass to form a film having a thickness of about 10 micrometers, and then cured by UV irradiation. The cured film was analyzed by SLM-12C to measure its EQE (43.66%) and OD (1.85).

### Example 12

20 parts by weight of the modified quantum dots in Example 2, 5 parts by weight of the modified high refractive particles in Example 8, 10 parts by weight of titanium dioxide serving as scattering particles, 3 parts by weight of photo initiator TPO, 31 parts by weight of hexamethylene diacrylate, and 31 parts by weight of isodecyl acrylate were mixed to form an ink. The ink was analyzed by Turbiscan Tower to measure its TSI. The ink had a TSI of 3.6. The ink was spun-coated on glass to form a film having a thickness of about 10 micrometers, and then cured by UV irradiation. The cured film was analyzed by SLM-12C to measure its EQE (41.25%) and OD (1.77).

### Example 13

15 parts by weight of the modified quantum dots in Example 1, 5 parts by weight of the modified high refractive particles in Example 8, 10 parts by weight of titanium dioxide serving as scattering particles, 3 parts by weight of photo initiator TPO, 33.5 parts by weight of hexamethylene diacrylate, and 33.5 parts by weight of isodecyl acrylate were mixed to form an ink. The ink was analyzed by Turbiscan Tower to measure its TSI. The ink had a TSI of 3.1. The ink was spun-coated on glass to form a film having a thickness of about 10 micrometers, and then cured by UV irradiation. The cured film was analyzed by SLM-12C to measure its EQE (42.77%) and OD (1.73).

### Example 14

15 parts by weight of the modified quantum dots in Example 3, 5 parts by weight of the modified high refractive particles in Example 8, 10 parts by weight of titanium dioxide serving as scattering particles, 3 parts by weight of photo initiator TPO, 33.5 parts by weight of hexamethylene diacrylate, and 33.5 parts by weight of isodecyl acrylate were mixed to form an ink. The ink was analyzed by Turbiscan Tower to measure its TSI. The ink had a TSI of 3.0. The ink was spun-coated on glass to form a film having a thickness of about 10 micrometers, and then cured by UV irradiation. The cured film was analyzed by SLM-12C to measure its EQE (41.18%) and OD (1.72).

### Comparative Example 2

15 parts by weight of the modified quantum dots in Example 2, 10 parts by weight of titanium dioxide serving as scattering particles, 3 parts by weight of photo initiator TPO, 36 parts by weight of hexamethylene diacrylate, and 36 parts by weight of isodecyl acrylate were mixed to form an ink. The ink was analyzed by Turbiscan Tower to measure its TSI. The ink had a TSI of 4.1. The ink was spun-coated on glass to form a film having a thickness of about 10 micrometers, and then cured by UV irradiation. The cured film was analyzed by SLM-12C to measure its EQE (39.47%) and OD (1.67).

### Comparative Example 3

15 parts by weight of the non-modified quantum dots C527, 10 parts by weight of titanium dioxide serving as scattering particles, 3 parts by weight of photo initiator TPO, 36 parts by weight of hexamethylene diacrylate, and 36 parts by weight of isodecyl acrylate were mixed to form an ink. The ink was analyzed by Turbiscan Tower to measure its TSI. The ink had a TSI of 4.2. The ink was spun-coated on glass to form a film having a thickness of about 10 micrometers, and then cured by UV irradiation. The cured film was analyzed by SLM-12C to measure its EQE (40.24%) and OD (1.62).

### Comparative Example 4

15 parts by weight of the non-modified quantum dots C527, 3 parts by weight of the modified high refractive particles in Example 8, 10 parts by weight of titanium dioxide serving as scattering particles, 3 parts by weight of photo initiator TPO, 34.5 parts by weight of hexamethylene diacrylate, and 34.5 parts by weight of isodecyl acrylate were mixed to form an ink. The ink was analyzed by Turbiscan Tower to measure its TSI. The ink had a TSI of 4.8. The ink was spun-coated on glass to form a film having a thickness of about 10 micrometers, and then cured by UV irradiation. The cured film was analyzed by SLM-12C to measure its EQE (40.10%) and OD (1.67).

### Comparative Example 5

15 parts by weight of the non-modified quantum dots C527, 5 parts by weight of the modified high refractive particles in Example 8, 10 parts by weight of titanium dioxide serving as scattering particles, 3 parts by weight of photo initiator TPO, 33.5 parts by weight of hexamethylene diacrylate, and 33.5 parts by weight of isodecyl acrylate were mixed to form an ink. The ink was analyzed by Turbiscan Tower to measure its TSI. The ink had a TSI of 6.7 (sedimentation and being separated to layers), and no subsequent property verification was performed for the ink.

### Comparative Example 6

15 parts by weight of the non-modified quantum dots C527, 10 parts by weight of the modified high refractive particles in Example 8, 10 parts by weight of titanium dioxide serving as scattering particles, 3 parts by weight of photo initiator TPO, 31 parts by weight of hexamethylene diacrylate, and 31 parts by weight of isodecyl acrylate were mixed to form an ink. The ink was analyzed by Turbiscan Tower to measure its TSI. The ink had a TSI of 8.9 (sedimentation and being separated to layers), and no subsequent property verification was performed for the ink.

### Comparative Example 7

15 parts by weight of the modified quantum dots in Example 2, 5 parts by weight of the non-modified high refractive particles in Example 8 (e.g. the oxide of zinc and zirconium), 10 parts by weight of titanium dioxide serving as scattering particles, 3 parts by weight of photo initiator TPO, 33.5 parts by weight of hexamethylene diacrylate, and 33.5 parts by weight of isodecyl acrylate were mixed to form an ink. The ink was analyzed by Turbiscan Tower to measure its TSI. The ink had a TSI of 4.6. The ink was spun-coated on glass to form a film having a thickness of about 10 micrometers, and then cured by UV irradiation. The cured film was analyzed by SLM-12C to measure its EQE (37.81%) and OD (1.45).

### Example 15

15 parts by weight of the modified quantum dots in Example 2, 5 parts by weight of the modified high refractive particles in Example 6, 10 parts by weight of titanium dioxide serving as scattering particles, 3 parts by weight of photo initiator TPO, 33.5 parts by weight of hexamethylene diacrylate, and 33.5 parts by weight of isodecyl acrylate were mixed to form an ink. The ink was analyzed by Turbiscan Tower to measure its TSI. The ink had a TSI of 2.8. The ink was spun-coated on glass to form a film having a thickness of about 10 micrometers, and then cured by UV irradiation. The cured film was analyzed by SLM-12C to measure its EQE (45.85%) and OD (1.78).

### Example 16

15 parts by weight of the modified quantum dots in Example 2, 5 parts by weight of the modified high refractive particles in Example 4, 10 parts by weight of titanium dioxide serving as scattering particles, 3 parts by weight of photo initiator TPO, 33.5 parts by weight of hexamethylene diacrylate, and 33.5 parts by weight of isodecyl acrylate were mixed to form an ink. The ink was analyzed by Turbiscan Tower to measure its TSI. The ink had a TSI of 2.6. The ink was spun-coated on glass to form a film having a thickness of about 10 micrometers, and then cured by UV irradiation. The cured film was analyzed by SLM-12C to measure its EQE (43.12%) and OD (1.81).

### Example 17

15 parts by weight of the modified quantum dots in Example 2, 5 parts by weight of the modified high refractive particles in Example 8, 20 parts by weight of titanium dioxide serving as scattering particles, 3 parts by weight of photo initiator TPO, 28.5 parts by weight of hexamethylene diacrylate, and 28.5 parts by weight of isodecyl acrylate were mixed to form an ink. The ink was analyzed by Turbiscan Tower to measure its TSI. The ink had a TSI of 4.8. The ink was spun-coated on glass to form a film having a thickness of about 10 micrometers, and then cured by UV irradiation. The cured film was analyzed by SLM-12C to measure its EQE (38.22%) and OD (1.65).

### Comparative Example 8

1 part by weight of the non-modified quantum dots C527, 1 part by weight of polyhedral oligomeric silsesquioxane having a thiol group (POSS-SH), 0.06 parts by weight of D-cysteine, and 0.78 parts by weight of mercaptosuccinic acid were added into 4.6 parts by weight of THF. The mixture was heated to 100° C. to reflux and react for 6 hours, such that POSS was grafted onto the surface of the quantum dots C527. The reaction result was cooled to room temperature and then filtered to obtain modified quantum dots. Energy-dispersive X-ray spectroscopy (EDX) analysis revealed the presence of a silicon signal on the modified quantum dots, indicating that POSS was grafted onto quantum dot C527.

15 parts by weight of the above modified quantum dots, 5 parts by weight of the modified high refractive particles in Example 8, 10 parts by weight of titanium dioxide serving as scattering particles, 3 parts by weight of photo initiator TPO, 33.5 parts by weight of hexamethylene diacrylate, and 33.5 parts by weight of isodecyl acrylate were mixed to form an ink. The ink was analyzed by Turbiscan Tower to measure its TSI. The ink had a TSI of 5.3 (sedimentation and being separated to layers).

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A modified quantum dot, comprising:
a quantum dot;
polyhedral oligomeric silsesquioxane (POSS) grafted onto a surface of the quantum dot; and
acrylate-containing siloxane oligomer grafted onto the surface of the quantum dot.

2. The modified quantum dot as claimed in claim 1, wherein the quantum dot comprises cadmium selenide (CdSe), cadmium sulfide (CdS), indium arsenide (InAs), indium phosphide (InP), or a combination thereof.

3. The modified quantum dot as claimed in claim 1, wherein the polyhedral oligomeric silsesquioxane comprises hexahedral oligosesquioxane, octahedral oligosesquioxane, decahedral oligosesquioxane, or dodecahedral oligosesquioxane.

4. The modified quantum dot as claimed in claim 1, wherein the quantum dot and the polyhedral oligomeric silsesquioxane have a weight ratio of 1:0.5 to 1:5.

5. The modified quantum dot as claimed in claim 1, wherein the quantum dot and the acrylate-containing siloxane oligomer have a weight ratio of 1:0.5 to 1:1.5.

6. A quantum dot composition, comprising:
the modified quantum dot as claimed in claim 1;
a modified high refractive particle, comprising:
a high refractive particle; and
a silane coupling agent having a double-bond grafted onto a surface of the high refractive particle,
wherein the high refractive particle includes (1) an oxide of zinc and titanium, and zinc and titanium have a weight ratio of 1:0.4 to 1:0.9, (2) an oxide of zirconium and titanium, and zirconium and titanium have a weight ratio of 1:0.1 to 1:2, or (3) an oxide of zinc and zirconium, and zinc and zirconium have a weight ratio of 1:0.8 to 1:2;
a scattering particle;
an initiator; and
an acrylate monomer.

7. The quantum dot composition as claimed in claim 6, wherein a total weight of the zinc and the titanium of the oxide of zinc and titanium, a total weight of the zirconium and the titanium of the oxide of zirconium and titanium, or a total weight of the zinc and the zirconium of the oxide of zinc and zirconium and a weight of the silane coupling agent having a double-bond have a ratio of 1:0.1 to 1:3.

8. The quantum dot composition as claimed in claim 6, wherein the high refractive particle has an average diameter of 10 nm to 120 nm.

9. The quantum dot composition as claimed in claim 6, wherein the silane coupling agent having a double-bond comprises 3-(trimethoxysilyl) propyl acrylate, 3-(triethoxysilyl) propyl acrylate, 3-(triethoxysilyl) propyl isocyanate, or 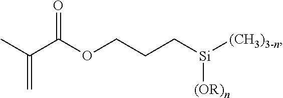
wherein R is methyl or ethyl, and n is an integer of 1-3.

10. The quantum dot composition as claimed in claim 6, wherein the modified quantum dot and the modified high refractive particle have a weight ratio of 1:0.1 to 1:1.

11. The quantum dot composition as claimed in claim 6, wherein the scattering particle is titanium dioxide, silicon oxide, or a combination thereof, and the scattering particle has an average diameter of 100 nm to 1000 nm.

12. The quantum dot composition as claimed in claim 6, wherein the modified quantum dot and the scattering particle have a weight ratio of 1:0.5 to 1:1.5.

13. The quantum dot composition as claimed in claim 6, wherein the initiator comprises photo initiator, thermal initiator, or a combination thereof.

14. The quantum dot composition as claimed in claim 6, wherein the acrylate monomer comprises hydroxyethyl methacrylate, 2-phenoxyethyl acrylate, β-carboxyethyl acrylate, isobornyl acrylate, hexamethylene diacrylate, isodecyl acrylate, trimethylolpropane trimethacrylate, or a combination thereof.

15. The quantum dot composition as claimed in claim 6, wherein the modified quantum dot and the acrylate monomer have a weight ratio of 1:3 to 1:5.

16. A film, being:
formed by reacting the quantum dot composition as claimed in claim 6 through light irradiation or heating.
